(19) United States
(12) Patent Application Publication
(10) Pub. No.: US 2010/0273036 A1
(43) Pub. Date: Oct. 28, 2010

(54) Lithium-Iron Disulfide Cell Design with Core Reinforcement

(75) Inventors: Jack W. Marple, Avon, OH (US); Michael F. Mansuetto, Bay Village, OH (US); Matthew T. Wendling, Avon, OH (US); Weiwei Huang, Westlake, OH (US); James Xixian Wu, North Olmsted, OH (US)

Correspondence Address: MICHAEL C. POPHAL;EVEREADY BATTERY COMPANY INC, 25225 DETROIT ROAD, P O BOX 450777, WESTLAKE, OH, 44145, US

(73) Assignee: Eveready Battery Company, Inc., St. Louis, MO (US)

(21) Appl. No.: 12/822,581

(22) Filed: Jun. 24, 2010

Related U.S. Application Data
(63) Continuation-in-part of application No. 11/581,992, filed on Oct. 17, 2006.

(51) Int. Cl. H01M 6/10; H01M 4/82

(52) U.S. Cl. 429/94; 29/623.1

(57) ABSTRACT

A electrochemical cell design, with particular applicability to lithium-iron disulfide batteries, is disclosed. The cell includes a spirally wound electrode assembly with a central core. The core causes uniform expansion within the cathode. The core may also collapse and/or possess a cross sectional shape that differs from the cross sectional shape of the cylindrical container which houses the electrode assembly.

### CROSS REFERENCE TO RELATED APPLICATIONS:

This application is a continuation-in-part of U.S. patent application Ser. No. 11/581,992 filed on Oct. 17, 2006 and published as U.S. Patent Publication No. 20080026293, which is incorporated by reference.

### FIELD OF INVENTION

The invention relates to primary electrochemical cells having a jellyroll electrode assembly that includes a lithium-based negative electrode, a positive electrode with a coating comprising iron disulfide deposited on a current collector and a polymeric separator. The separator, anode and cathode are wound into a jellyroll configuration around a rigid or solid central core which minimizes the internal volume of the cell in which the jellyroll may expand and/or controls the manner in which such expansion occurs. The resulting cell design has improved reliability and capacity on low drain rate tests, while still maintaining comparatively good high drain rate capacity.

### BACKGROUND

Electrochemical cells are presently the preferred method of providing cost effective portable power for a wide variety of consumer devices. The consumer device market dictates that only a handful of standardized cell sizes (e.g., AA or AAA) and specific nominal voltages (typically 1.5 V) be provided in such cells. Moreover, consumer electronic devices, such as digital still cameras, are designed with relatively high power operating requirements. Consumers in this market often prefer and opt to use primary batteries for their convenience, reliability, sustained shelf life and more economical per unit price as compared to currently available rechargeable (i.e., secondary) batteries.

Within the realm of 1.5 V systems, lithium-iron disulfide (also referred to as LiFeS₂, lithium pyrite or lithium iron pyrite) batteries offer higher energy density, especially at high drain rates, as compared to alkaline, carbon zinc or other systems. The comparative design and engineering considerations for any electrochemical system, and particularly between lithium-iron disulfide and other 1.5 V systems, are quite distinct. For example, the cathodes of primary lithium-iron disulfide batteries do not pose the same thermal runaway concerns as those in lithium-ion and other secondary lithium batteries, whose discharge mechanisms, cell components and safety considerations are also, by and large, inconsequential and/or inapplicable to primary lithium-iron disulfide systems.

Even with the inherent advantages of lithium-iron disulfide batteries for high power devices, cell designs must strike a balance between the cost of materials used, the incorporation of necessary safety devices and the overall reliability, delivered capacity and intended use of the designed cell. For example, a jellyroll design maximizes the surface area between the electrodes and allows for greater discharge efficiencies, but in doing so, might sacrifice capacity on low power and low rate discharges because it uses more inactive materials, such as separator and current collector(s) (both of which occupy internal volume, thereby requiring removal of active materials from the cell design).

In addition to improved capacity, cell designers must also consider other important characteristics, such as safety and reliability. Safety devices normally include venting mechanisms and thermally activated “shutdown” elements, such as positive thermal circuits (PTCs). Improvements to reliability primarily focus on preventing internal short circuits. In both instances, these characteristics also require elements that occupy internal volume and/or design considerations that are usually counterproductive to cell internal resistance, efficiency and discharge capacity. Transportation regulations further constraints because these regulations may limit the amount of lithium and the percent amount of weight lithium batteries can lose during thermal cycling impose, which means smaller container sizes like AA and AAA can only lose milligrams of total cell weight. Plus, the reactive and volatile nature of the active materials and the non-aqueous, organic electrolyte severely limits the universe of potential materials available.

One of the most difficult challenges that is unique to the lithium-iron disulfide primary battery system relates to the expansion of the cathode during discharge, which is exacerbated during low drain rates (e.g., <20 mA continuous) and/or elevated temperatures (e.g., >45° C. and, more typically, >70° C.). The cumulative reaction products of this system are known to be of a significantly lower density than the original active materials. Thus, even though the lithium anode is consumed during discharge, the overall volume of all of the materials contained within the cell increases, thereby exerting an outwardly expanding forces on the cell container. These forces may be on the order of several thousand pounds of pressure per square inch, and have been known to cause bulging or even splitting of the container. Even with the use of a high hoop strength cylindrical container (as compared to a prismatic form factor), the forces exerted on the internal components, and especially the separator, may be strong enough to also physically compromise these materials, thereby causing a direct short and/or failure of the cell to deliver its expected capacity. In fact, the expansion problem for lithium-iron disulfide batteries can be orders of magnitude greater than “swelling” issues observed in secondary battery systems, which lends further credence to the inapplicability of lithium secondary battery cell designs to the unique problems posed by the lithium-iron disulfide primary system.

One proposed means of handling these problems was to strike an appropriate balance between optimal internal volume utilization and acceptable LiFeS₂ cell capacity/performance. For example, a possible solution disclosed in U.S. Pat. No. 4,379,815 is to balance cathode expansion and anode contraction by mixing one or more other active materials (such as CuO, Bi₂O₃, Pb₂Bi₂O₅, P₃O₄, CoS₂) with pyrite, although these additional materials may negatively affect the desired discharge characteristics of the cell, and the capacity and efficiency, in comparison to a comparable lithium iron-disulfide-only cell, will suffer.

Another means of accommodating cathode expansion was to balance the yield strength of that container against the void space within the container or the amount of active material in the cathode formulation. For example, in U.S. Patent Publication Nos. 2005/0112462, filed on Nov. 21, 2003, and 2005/0233214, filed on Dec. 22, 2004, the failure of the separator's physical integrity, which is itself dependent upon the tensile strength in both the web and cross web direction, occurs as the designed amount of electrode void volume decreases (expressed there as a function of jellyroll cross sectional void in FIG. 2). In turn, the failure of the separator results in a loss of a battery's expected/designed capacity. In U.S. Patent Publication No. 2009/0104520, filed on Oct. 17, 2008, the dry mix density of the cathode mix and/or the weight percentages of cathode formulation components are selected to target a defined range of yield strengths for the container material. In either case, a certain minimum level of cell void must be maintained to allow for expansion of the cathode. Thus, cell designs incorporating built-in winding mandrels or safety “pins assemblies”, such as disclosed in U.S. Pat. No. 4,259,416 or U.S. Publication No. 2010/0021801, are limited only to lithium secondary systems.

Additional reasons exist for addressing void space that exists in lithium-iron disulfide primary batteries. For example, as disclosed in U.S. Publication No. 2010/0086833, artisans may be motivated to increase the volume of electrolyte (or other active cell components) to address the peculiarities caused by the discharge products of lithium-iron disulfide batteries.

### SUMMARY OF INVENTION

The invention is rooted, at least in part, in the understanding that improvements to capacity represent a fundamentally sound battery design. That is, in order to deliver greater capacity, careful consideration must be given to the radial expansion forces and other dynamics at work in a discharging lithium-iron disulfide battery. For example, if the design provides inadequate thickness in the separator (or any other essential cell component), then the radial expansion forces in the cathode during discharge may cause a hard short and/or an actual physical disconnection or severing in one or both electrodes. A hard short poses a significant safety concern and will almost immediately destroy the battery's utility, while the battery will cease to deliver capacity regardless of whether the active materials have all been discharged once such a disconnect occurs. Similar situations arise with respect to maintaining the integrity of the electrical connections, the closure/venting mechanism for the battery and the like. Thus, the capacity of a battery can be a significant metric for the overall viability and robustness of a cell design, particularly when the cell designer is limited to the use of a standard-sized consumer battery (e.g., AA or FR6; AAA or FR03; etc.)

As a corollary to the capacity acting as a de facto metric for battery design, those skilled in the art will appreciate that design choices, and particularly the selection of specific components, must be made in consideration of the overall battery system. A specific composition may have surprising, unexpected or unintended effects upon the other components and compositions within the cell. Similarly, in standard sized batteries, the selection of a particular element necessarily occupies volume within the container that might otherwise have been available for other elements. Thus, this interdependency of design choices dictates that any increase in capacity, and especially an increase that does not negatively impact the safety or performance of the battery in other regards, is much more than a simple act of adding more active materials.

The inventors have now discovered, quite surprisingly, by reducing and/or specifically restricting the amount of void space available for cathode expansion within the container of certain types of LiFeS₂ cells, the resulting battery can sustain prolonged capacity and service life. This discovery is most noticeable in low drain, high temperature conditions when cathode expansion of pyrite is typically at its worst. Consequently, a structure for an electrochemical battery cell, a method of making such a battery and a method for discharging such a battery are all contemplated. To the extent the use of cylindrical inserts with circumferential shapes that differ from the corresponding shape of the container's inner diameter and/or the outer shape of the electrode assembly itself is contemplated, this discovery may not necessarily be limited to lithium-iron disulfide cells.

In one embodiment of the invention, a 1.5 volt primary lithium-iron disulfide battery is contemplated. The battery has a round, cylindrical container with a top cover fitted over an open end of the container; a spirally wound electrode assembly including an anode consisting essentially of metallic foil of lithium or a lithium alloy, a polymeric separator and a cathode comprising a cathode mixture including iron disulfide at least partially coated onto both sides of a metallic current collector; and a core disposed concentrically within the electrode assembly to promote uniform expansion of the cathode mixture as the battery is discharged. Additional features in this embodiment may include any one or combination of the following:
wherein the core comprises an inert, cylindrical rod;
wherein the rod is constructed from an insulating polymer;
wherein the polymer is selected from the group consisting of: polypropylene, polyethylene and ethylene chlorotrifluoroethylene copolymer;
wherein the core comprises a portion of the cathode;
wherein the portion of the cathode at the core is not coated with cathode mixture;
wherein the portion of cathode constitutes more than one wind of the spirally wound electrode assembly;
wherein the core has a cross-sectional shape that is not the same as the cross-sectional shape of the container;
further comprising at least one lead affixed to the electrode assembly at a point selected to reduce stress on the electrode assembly caused by the lead as the battery is discharged;
wherein the cross-sectional shape of the core is selected from the group consisting of: circular, oval, rectangular, triangular or C-shaped;
wherein the core is constructed to collapse in a uniform manner as the battery is discharged;
wherein the metallic current collector has an outer facing side and an inner facing side and wherein a greater amount of iron disulfide is coated onto the outer facing side as compared to iron disulfide coated onto the inner facing side;
further comprising a welded lead electrically connecting the electrode assembly to either the container or the top cover and wherein the electrode assembly has an outer diameter and the container has an inner diameter so that, prior to discharge of the battery, a continuous void exists between the inner diameter and the outer diameter;
wherein the core promotes uniform expansion of the cathode mixture as the battery is discharged; and/or
wherein the core comprises a winding mandrel.

In a second embodiment, an electrochemical cell is considered. The cell has a cylindrical container having a height that is greater than a diameter; a spirally wound electrode assembly including an anode, a separator and a cathode; and a cylindrical core concentrically disposed within the electrode assembly having a cross sectional shape that differs from a cross sectional shape of the cylindrical container across the entire height of the container. Additional aspects of the cell may be selected from any one or combination of the following:
wherein the cross sectional shape of the cylindrical container is circular;
wherein the cross sectional shape of the cylindrical core is selected from the group consisting of: oval, rectangular, triangular or C-shaped;
wherein the cylindrical core is hollow;
wherein a lead is affixed within the electrode assembly proximate to a flattened circumferential portion of the cross sectional shape of the core;
wherein the core is constructed to collapse in a uniform manner as the battery is discharged; and/or
wherein the core comprises a winding mandrel.

In another embodiment, a method of manufacturing a primary lithium-iron disulfide battery is disclosed. The method includes the steps of creating a spiral wound electrode assembly including a lithium or lithium alloy anode and an iron disulfide cathode at least partially coated onto both sides of a thin metallic strip so that the electrode assembly has an outer circumferential shape and a central aperture with an inner circumferential shape; conforming the electrode assembly so as to uniformly maintain integrity of the electrode assembly when the battery is subsequently discharged; and disposing the electrode assembly within a cylindrical container having a height that is greater than a diameter. Additional steps can include any one or combination of the following:
wherein the conforming the electrode assembly is accomplished by disposing a cylindrical rod concentrically within the central aperture of the electrode assembly;
wherein the cylindrical rod is designed to collapse in a uniform manner as the battery is subsequently discharged;
wherein the cylindrical rod has a outer circumferential shape that: i) matches the inner shape of the central aperture, and ii) is different from a shape of the cylindrical container;
wherein the outer shape of the cylindrical rod is selected from the group consisting of: oval, rectangular, triangular or C-shaped;
wherein the conforming the electrode assembly is accomplished by physically compressing the electrode assembly to alter the inner shape of the central aperture;
wherein the inner shape of the central aperture is selected from the group consisting of: oval, rectangular, triangular or C-shaped;
wherein the conforming the electrode assembly is accomplished by coating more iron disulfide on one side as compared to an opposing side of the thin metallic strip;
wherein the electrode assembly has an outer diameter and the container has an inner diameter and the electrode assembly is disposed within the container so that, prior to discharge of the battery, a continuous void exists between the inner diameter and the outer diameter and further comprising welding a lead electrically connecting the electrode assembly to either the container or a top cover fitted over an open end of the container; and/or
wherein the cylindrical rod is a winding mandrel used to create the spiral wound electrode assembly.

In a still further embodiment, a method of manufacturing a battery including creating a spiral wound electrode assembly so that the electrode assembly has an outer circumferential shape and a central aperture with an inner circumferential shape; conforming the electrode assembly so as to impart a shape to the central aperture that is different than the outer circumferential shape of the assembly; and disposing the electrode assembly within a cylindrical container having a height that is greater than a diameter. Additional embodiments may include any one or combination of the following:
wherein the conforming the electrode assembly is accomplished by disposing a cylindrical rod concentrically within the central aperture of the electrode assembly and wherein the cylindrical rod having a outer circumferential shape that: i) matches the inner shape of the central aperture, and ii) is different from a shape of the cylindrical container;
wherein the outer circumferential shape of the cylindrical rod is selected from the group consisting of: circular, oval, rectangular, triangular or C-shaped;
wherein the cylindrical rod is a winding mandrel used to create the spiral wound electrode assembly; and/or
wherein the conforming the electrode assembly is accomplished by physically compressing the electrode assembly.

A fourth embodiment contemplates an electrochemical cell comprising a cylindrical container having a height that is greater than a diameter and a top cover fitted over an open end of the container; a spirally wound electrode assembly including an anode, a separator and a cathode; a cylindrical core concentrically disposed within the electrode assembly; and wherein one of the following conditions applies: A) the core has a cross sectional shape that differs from a cross sectional shape of the cylindrical container; or B) the anode consists essentially of metallic foil of lithium or a lithium alloy, the cathode comprises a cathode mixture including iron disulfide at least partially coated onto a metallic current collector, the container has a circular cross sectional shape and at least one of the following: i) the core collapses in a uniform manner when the battery is subsequently discharged; and ii) the core has a cross sectional shape that differs from a cross sectional shape of the cylindrical container. Further features in this embodiment may include any one or combination of the following:
wherein the cross sectional shape of the cylindrical container is circular and the cross sectional shape of the core is selected from the group consisting of: oval, rectangular, triangular or C-shaped;
wherein the core is hollow;
further comprising at least one lead affixed within the electrode assembly proximate to a flattened circumferential portion of the cross sectional shape of the core;
wherein the core is a rod is an inert cylindrical rod and, more preferably, is a cylindrical rod constructed from an insulating polymer from the group consisting of: polypropylene, polyethylene and ethylene chlorotrifluoroethylene copolymer;
wherein the core consists of: a portion of the cathode, an intergal winding mandrel, a portion of the cathode that is not coated on one side with the cathode mixture or a portion of the cathode that is not coated on either side with the cathode mixture;

A final embodiment considers a method for manufacturing a battery including the steps of creating a spiral wound electrode assembly so that the electrode assembly has an outer circumferential shape and a central aperture with an inner circumferential shape; conforming the electrode assembly so as to impart a shape to the central aperture that is different than the outer circumferential shape of the assembly; and disposing the electrode assembly within a cylindrical container having a height that is greater than a diameter. In this instance, additional steps might include any one or combination of the following:
wherein the conforming the electrode assembly is accomplished by disposing a cylindrical rod concentrically within the central aperture of the electrode assembly and wherein the cylindrical rod having a outer circumferential shape that: i) matches the inner shape of the central aperture, and ii) is different from a shape of the cylindrical container;
wherein the outer circumferential shape of the cylindrical rod is selected from the group consisting of: circular, oval, rectangular, triangular or C-shaped;
wherein the cylindrical rod is a winding mandrel used to create the spiral wound electrode assembly;
wherein the cylindrical rod is designed to collapse in a uniform manner as the battery is subsequently discharged;
wherein the conforming the electrode assembly is accomplished by physically compressing the electrode assembly; and/or
wherein the shape of the central aperture is selected from the group consisting of: oval, rectangular, triangular or C-shaped.

### BRIEF DESCRIPTION OF DRAWINGS

FIG. 1 illustrates one embodiment of a cell design for a lithium-iron disulfide electrochemical cell.

FIGS. 2A through 2C illustrate cross sectional configurations of the electrode assembly and core according to certain embodiments of the invention.

FIGS. 3A and 3B illustrate cross sectional images of an electrode assembly according to the prior art, taken both before and after the cell has been discharged.

### DESCRIPTION OF A PREFERRED EMBODIMENT OF THE INVENTION

Unless otherwise specified, as used herein the terms listed below are defined and used throughout this disclosure as follows:
ambient temperature or room temperature—between about 20° C. and about 25° C.; unless otherwise stated, all examples, data and other performance and manufacturing information were conducted at ambient temperature;
anode—the negative electrode; more specifically, in a lithium-iron disulfide cell, it consists essentially of lithium and/or lithium-based alloy (i.e., an alloy containing at least 90% lithium by weight) as the sole electrochemically active material, without the use of a distinct, full-electrode length current collector;
capacity—the capacity delivered by a single electrode or an entire cell during discharge at a specified set of conditions (e.g., drain rate, temperature, etc.); typically expressed in milliamp-hours (mAh) or milliwatt-hours (mWh) or by the number of images taken under a digital still camera test;
cathode—the positive electrode; more specifically, in a lithium-iron disulfide cell, it consists essentially of a cathode mixture including iron disulfide (and/or doped derivatives thereof) as the primary electrochemically active material (e.g., greater than 50%, more preferably greater than 80% to 95%, and most preferably 100%) and optional rheological, polymeric and/or conductive additives at least partially coated onto both sides of a metallic current collector substrate; this definition specifically excludes cathodes that are in pellet form;
cell housing—the structure that physically encloses the electrode assembly, including all internally enclosed safety devices, inert components and connecting materials which comprise a fully functioning battery; typically these components will include a container (formed in the shape of a cup, also referred to as a “can”) and a closure (fitting over the opening of the container and normally including venting and sealing mechanisms for impeding electrolyte egress and moisture/atmospheric ingress); depending upon the context may sometimes be used interchangeably with the terms “can” or “container”;
cylindrical cell size—any cell housing having a cylinder with a height that is greater than its diameter; this definition specifically excludes button cells, miniature cells or experimental “hockey puck” cells;
Digital Still Camera Test (also referred to as the ANSI Digital Still Camera Test)—a camera takes two pictures (images) every minute until the battery life is exhausted, following the testing procedure outlined in ANSI C18.3M, Part 1—2005 published by the American National Standard for Portable Lithium Primary Cells and Batteries—General and Specifications and entitled, “Battery Specification 15LF (AA lithium iron disulfide), Digital camera test”. This test consists of discharging a AA sized lithium iron disulfide battery at 1500 mW for 2 seconds followed by 650 mW for 28 second, with this 30 second cycle repeated for a total cycle of 5 minutes (10 cycles) and followed by a rest period (i.e., 0 mW) for 55 minutes. The entire hourly cycle 24 hours per day until a final 1.05 voltage or less is recorded. Each 30 second cycle is intended to represent one digital still camera image.
electrochemically active material—one or more chemical compounds that are part of the discharge reaction of a cell and contribute to the cell discharge capacity, including small amounts (e.g., less than 10%, more preferably less than 5%, and most preferably less than 1%) of impurities and other moieties inherent to that material;
electrode assembly interfacial area—the total area of the jellyroll electrode assembly wherein the anode, cathode and separator are all aligned so as to allow for an electrochemical reaction (for example, the electrode assembly interfacial height in a cylindrically shaped jellyroll electrode assembly would be determined by the longitudinal axis along all points where the anode, cathode and separator are perpendicularly adjacent to one another on that axis);
FR6 cell—With reference to International Standard IEC-60086-1 published by the International Electrotechnical Commission on or after November 2000, a cylindrical cell size lithium iron disulfide battery with a maximum external height of about 50.5 mm and a maximum external diameter of about 14.5 mm;
FR03 cell—With reference to International Standard IEC-60086-1 published by the International Electrotechnical Commission on or after November 2000, a cylindrical cell size lithium iron disulfide battery with a maximum external height of about 44.5 mm and a maximum external diameter of about 10.5 mm;
“jellyroll” electrode assembly—strips of anode and cathode, along with an appropriate polymeric separator, are combined into an assembly by winding along their lengths or widths, e.g., around a mandrel or central core; used synonymously and interchangeably with spirally wound electrode assembly;
loading—with respect to the final dried and densified cathode mix coated to the foil current collector, the amount of specified material found a single facing of a specified area of the current collector, typically expressed as milligrams of total cathode mix (i.e., including pyrite, binders, conductors, additives, etc.) on a single side of a one square centimeter portion of the cathode collector that is interfacially aligned;
nominal—a value, typically specified by the manufacturer, that is representative of what can be expected for that characteristic or property;
pyrite—a preferred mineral form of iron disulfide, typically containing at least 90% and more preferably at least 95% of electrochemically active iron disulfide when used in batteries; may also be referred to as iron pyrite;
solids packing—in a coating, but excluding the current collector, the ratio of volume in the coating occupied by solid particles (e.g., electrochemically active material, binder, conductor, etc.) as compared to the total volume of that coating, measured after the coating has been dried and densified; typically expressed as a percentage but also can be expressed as the inverse of the coating's porosity (i.e., 100% minus the percent porosity of the coating);
specific energy density—the capacity of the electrode, cell or battery, according to the stated conditions (e.g., discharge at 200 mA continuous drain, total input on an interfacial capacity, etc.) divided by the total weight of the entire cell or battery generally expressed in watt-hours/kilogram (Wh/kg) or milliwatt-hours/gram (mWh/g);

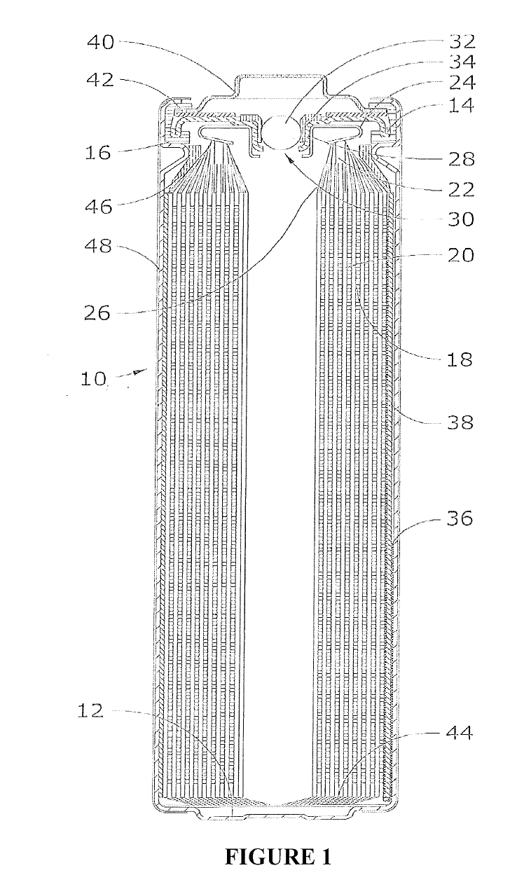

The invention will be better understood with reference to FIG. 1. In FIG. 1, the cell 10 is one embodiment of a FR6 (AA) type cylindrical LiFeS₂ battery cell, although the invention should have equal applicability to FR03 (AAA) or other cylindrical cells. The cell 10 has, in one embodiment, a housing that includes a container in the form of can 12 with a closed bottom and an open top end that is closed with a cell cover 14 and a gasket 16. The can 12 has a bead or reduced diameter step near the top end to support the gasket 16 and cover 14. The gasket 16 is compressed between the can 12 and the cover 14 to seal an anode or negative electrode 18, a cathode or positive electrode 20 and liquid electrolyte (not shown) within the cell 10.

The anode 18, cathode 20 and a separator 26 are spirally wound together into an electrode assembly. The cathode 20 has a metal current collector 22, which extends from the top end of the electrode assembly and is connected to the inner surface of the cover 14 with a contact spring 24. The anode 18 is electrically connected to the inner surface of the can 12 by a metal lead (or tab) 36. The lead 36 is fastened to the anode 18, extends from the bottom of the electrode assembly, and is folded across the bottom and up along the side of the electrode assembly. The lead 36 makes pressure contact with the inner surface of the side wall of the can 12. After the electrode assembly is wound, it can be held together before insertion by tooling in the manufacturing process, or the outer end of material (e.g., separator or polymer film outer wrap 38) can be fastened down, by heat sealing, gluing or taping, for example.

In one embodiment, an insulating cone 46 is located around the peripheral portion of the top of the electrode assembly to prevent the cathode current collector 22 from making contact with the can 12, and contact between the bottom edge of the cathode 20 and the bottom of the can 12 is prevented by the inward-folded extension of the separator 26 and an electrically insulating bottom disc 44 positioned in the bottom of the can 12.

In one embodiment, the cell 10 has a separate positive terminal cover 40 has one or more vent apertures (not shown) and is held in place by the inwardly crimped top edge of the can 12 and the gasket 16. The can 12 may serve as the negative contact terminal. An insulating jacket, such as an adhesive label 48, can be applied to the side wall of the can 12.

In one embodiment, disposed between the peripheral flange of the terminal cover 40 and the cell cover 14 is a positive temperature coefficient (PTC) device 42 that substantially limits the flow of current under abusive electrical conditions. In another embodiment, the cell 10 may also include a pressure relief vent. The cell cover 14 has an aperture comprising an inward projecting central vent well 28 with a vent hole 30 in the bottom of the well 28. The aperture is sealed by a vent ball 32 and a thin-walled thermoplastic bushing 34, which is compressed between the vertical wall of the vent well 28 and the periphery of the vent ball 32. When the cell internal pressure exceeds a predetermined level, the vent ball 32, or both the ball 32 and bushing 34, is/are forced out of the aperture to release pressurized gases from the cell 10. In other embodiments, the pressure relief vent can be an aperture closed by a rupture membrane, similar to those disclosed in U.S. Pat. No. 7,687,189, which is incorporated by reference, or a membrane with relatively thin area such as a coined groove, that can tear or otherwise break, to form a vent aperture in a portion of the cell, such as a sealing plate or container wall.

The electrical connection is maintained between each of the electrodes and the opposing external battery terminals, which are proximate to or integrated with the housing. In one embodiment, the terminal portion of the electrode lead disposed between the side of the electrode assembly and the side wall of the can, may have a shape prior to insertion of the electrode assembly into the can, preferably non-planar that enhances electrical contact with the side wall of the can and provides a spring-like force to bias the lead against the can side wall. During cell manufacture, the shaped terminal portion of the lead can be deformed, e.g., toward the side of the electrode assembly, to facilitate its insertion into the can, following which the terminal portion of the lead can spring partially back toward its initially non-planar shape, but remain at least partially compressed to apply a force to the inside surface of the side wall of the can, thereby making good physical and electrical contact with the can. One example of such a lead is disclosed in U.S. Pat. No. 7,618,742, which is incorporated by reference. Alternatively, this electrical connection, and/or others within the cell, may also be maintained by way of welding.

The electrical lead(s) can be made from a thin metal strip connecting the anode or negative electrode to one of the cell terminals (the can in the case of the FR6 cell shown in FIG. 1). This may be accomplished embedding an end of the lead within a portion of the anode or by simply pressing a portion such as an end of the lead onto the surface of the lithium foil. The lithium or lithium alloy has adhesive properties and generally at least a slight, sufficient pressure or contact between the lead and electrode will weld the components together. The negative electrode may be provided with a lead prior to winding into a jellyroll configuration. The lead may also be connected to the lithium and/or other components via appropriate welds.

The metal strip comprising the lead 36 is often made from nickel or nickel plated steel with sufficiently low resistance (e.g., generally less than 15 mΩ/cm and preferably less than 4.5 mΩ/cm) in order to allow sufficient transfer of electrical current through the lead. Examples of suitable negative electrode lead materials include, but are not limited to, copper, copper alloys, for example copper alloy 7025 (a copper, nickel alloy comprising about 3% nickel, about 0.65% silicon, and about 0.15% magnesium, with the balance being copper and minor impurities); and copper alloy 110; and stainless steel. Lead materials should be chosen so that the composition is stable within the electrochemical cell including the nonaqueous electrolyte.

The cell container is often a metal can with a closed bottom such as the can in FIG. 1. The can material and thickness of the container wall will depend in part of the active materials and electrolyte used in the cell. A common material type is steel. For example, the can may be made of cold rolled steel (CRS), and may be plated with nickel on at least the outside to protect the outside of the can from corrosion. Typically, CRS containers according to the invention can have a wall thickness between 7 and 10 mils for a FR6 cell, or 6 to 9 mils for a FR03 cell. The type of plating can be varied to provide varying degrees of corrosion resistance, to improve the contact resistance or to provide the desired appearance. The type of steel will depend in part on the manner in which the container is formed. For drawn cans, the steel can be a diffusion annealed, low carbon, aluminum killed, SAE 1006 or equivalent steel, with a grain size of ASTM 9 to 11 and equiaxed to slightly elongated grain shape. Other steels, such as stainless steels, can be used to meet special needs. For example, when the can is in electrical contact with the cathode, a stainless steel may be used for improved resistance to corrosion by the cathode and electrolyte.

The cell cover can be metal. Nickel plated steel may be used, but a stainless steel is often desirable, especially when the closure and cover are in electrical contact with the cathode. The complexity of the cover shape will also be a factor in material selection. The cell cover may have a simple shape, such as a thick, flat disk, or it may have a more complex shape, such as the cover shown in FIG. 1. When the cover has a complex shape like that in FIG. 1, a type 304 soft annealed stainless steel with ASTM 8-9 grain size may be used to provide the desired corrosion resistance and ease of metal forming. Formed covers may also be plated, with nickel for example, or made from stainless steel or other known metals and their alloys.

The terminal cover should have good resistance to corrosion by water in the ambient environment or other corrosives commonly encountered in battery manufacture and use, good electrical conductivity and, when visible on consumer batteries, an attractive appearance. Terminal covers are often made from nickel plated cold rolled steel or steel that is nickel plated after the covers are formed, although stainless steels are also possible. Where terminals are located over pressure relief vents, the terminal covers generally have one or more holes to facilitate cell venting.

The gasket used to perfect the seal between the can and the closure/terminal cover may be made from any suitable thermoplastic material that provides the desired sealing properties. Material selection is based in part on the electrolyte composition. Examples of suitable materials include polypropylene, polyphenylene sulfide, tetrafluoride-perfluoroalkyl vinylether copolymer, polybutylene terephthalate and combinations thereof. Preferred gasket materials include polypropylene (e.g., PRO-FAX® 6524 from Basell Polyolefins in Wilmington, Del., USA) and polyphenylene sulfide (e.g., XTEL™ XE3035 or XE5030 from Chevron Phillips in The Woodlands, Tex., USA). Small amounts of other polymers, reinforcing inorganic fillers and/or organic compounds may also be added to the base resin of the gasket. Examples of suitable materials can be found in U.S. Patent Publication Nos. 20080226982 and U.S. Pat. No. 7,670,715, which are incorporated by reference.

The gasket may be coated with a sealant to provide the best seal. Ethylene propylene diene terpolymer (EPDM) is a suitable sealant material, but other suitable materials may be used.

The cell can be closed and sealed using any suitable process. Such processes may include, but are not limited to, crimping, redrawing, colleting and combinations thereof For example, for the cell in FIG. 1, a bead is formed in the can after the electrodes and insulator cone are inserted, and the gasket and cover assembly (including the cell cover, contact spring and vent bushing) are placed in the open end of the can. The cell is supported at the bead while the gasket and cover assembly are pushed downward against the bead. The diameter of the top of the can above the bead could be reduced with a segmented collet to hold the gasket and cover assembly in place in the cell. After electrolyte is dispensed into the cell through the apertures in the vent bushing and cover, a vent ball is inserted into the bushing to seal the aperture in the cell cover. A PTC device and a terminal cover are placed onto the cell over the cell cover, and the top edge of the can is bent inward with a crimping die to hold and retain the gasket, cover assembly, PTC device and terminal cover and complete the sealing of the open end of the can by the gasket.

The anode comprises a strip of lithium metal, sometimes referred to as lithium foil. The composition of the lithium can vary, though for battery grade lithium the purity is always high. The lithium can be alloyed with other metals, such as aluminum, to provide the desired cell electrical performance or handling ease, although the amount of lithium in any alloy should nevertheless be maximized so that special alloys specifically designed for high temperature applications (i.e., above the melting point of pure lithium) are not preferred. Appropriate battery grade lithium-aluminum foil, containing 0.5 weight percent aluminum, is available from Chemetall Foote Corp., Kings Mountain, N.C., USA. An anode consisting essentially of lithium or a lithium alloy (for example, 0.5 wt. % Al and 99+ wt. % Li) is preferred, with an emphasis placed on maximizing the amount of active material (i.e., lithium) in any such alloy.

As in the cell in FIG. 1, a separate current collector (i.e., an electrically conductive member, such as a metal foil, on which the anode is welded or coated, or an electrically conductive strip running along substantial portions the length of the anode such that the collector would be spirally wound within the jellyroll) is not needed for the anode, since lithium has a high electrical conductivity. By not utilizing such a current collector, more space is available within the container for other components, such as active materials. If used, an anode current collectors could be made of copper and/or other appropriate high conductivity metals that are stable when exposed to the other interior components of the cell (e.g., electrolyte).

The separator is a thin microporous membrane that is ion-permeable and electrically nonconductive. It is capable of holding at least some electrolyte within the pores of the separator. The separator is disposed between adjacent surfaces of the anode and cathode to electrically insulate the electrodes from each other. Portions of the separator may also insulate other components in electrical contact with the cell terminals to prevent internal short circuits. Edges of the separator often extend beyond the edges of at least one electrode to insure that the anode and cathode do not make electrical contact even if they are not perfectly aligned with each other. However, it is desirable to minimize the amount of separator extending beyond the electrodes.

To provide good high power discharge performance, it is desirable that the separator have the characteristics (pores with a smallest dimension of at least about 0.005 μm and a largest dimension of no more than about 5 μm across, a porosity in the range of about 30 to 70 percent, an area specific resistance of from 2 to 15 ohm-cm2 and a tortuosity less than 2.5) disclosed in U.S. Pat. No. 5,290,414, issued Mar. 1, 1994, and hereby incorporated by reference. Other desirable separator properties are described in U.S. Patent Publication No. 20080076022, which is hereby incorporated by reference.

Separators are often made of polypropylene, polyethylene or both. The separator can be a single layer of biaxially oriented microporous membrane, or two or more layers can be laminated together to provide the desired tensile strengths in orthogonal directions. A single layer is preferred to minimize the cost. The membrane should have a preferred thickness between 16 and 25 microns. Suitable separators are available from Tonen Chemical Corp., Macedonia, N.Y., USA and Entek Membranes in Lebanon, Oreg., USA.

A nonaqueous electrolyte, containing water only in very small quantities (e.g., typically less than 2000 ppm, and more preferably less than about 500 parts per million, by weight, depending on the electrolyte salt being used), is used in the battery cell of the invention. The electrolyte contains one or more lithium-based electrolyte salts dissociated in one or more organic solvents. Suitable salts include one or more of the following: lithium bromide, lithium perchlorate, lithium hexafluorophosphate, potassium hexafluorophosphate, lithium hexafluoroarsenate, lithium trifluoromethanesulfonate and lithium iodide, although the salt preferably includes I⁻ (e.g., by dissociation of LiI in the solvent blend). Additives that result in the creation of I⁻ dissociated in the solvent blend may also be used.

Suitable organic solvents include one or more of the following: methyl formate, γ-butyrolactone, sulfolane, acetonitrile, 3,5-dimethylisoxazole, n,n-dimethyl formamide and ethers, with at least 50 volume percent of the total solvents preferred constituting ethers because their low viscosity and wetting capability. Preferred ethers can be acyclic (e.g., 1,2-dimethoxyethane, 1,2-diethoxyethane, di(methoxyethyl)ether, triglyme, tetraglyme and diethyl ether) and/or cyclic (e.g., 1,3-dioxolane, tetrahydrofuran, 2-methyl tetrahydrofuran and 3-methyl-2-oxazolidinone). 1,3-dioxolane and 1,2-dimethoxyethane are the preferred solvents, while lithium iodide is the preferred salt, although it may be used in combination with lithium triflate, lithium imide or lithium perchlorate. Substituted derivatives or other analogs may be used in combination with, or in place of, the preferred solvents identified above.

The cathode is in the form of a strip that comprises a current collector and a cathode mixture coated thereon including one or more electrochemically active materials, usually in particulate form. Iron disulfide (FeS₂) is primary active material in the cathode mix, preferably provided in the form of pyrite. The cathode can also contain small amounts of one or more additional active materials, depending on the desired cell electrical and discharge characteristics. The additional active cathode material may be any suitable active cathode material. Other additives, such as conductive diluents, binder materials and processing aides, are also included in the cathode mixture.

Preferably, the active material for a Li/FeS₂ cell cathode comprises at least about 95 weight percent FeS₂, and most preferably FeS₂ is the sole active cathode material. Pyrite having a preferred purity level of at least 95 weight percent FeS₂ (i.e., “battery grade”) is available from Washington Mills, North Grafton, Mass., USA; Chemetall GmbH, Vienna, Austria; and Kyanite Mining Corp., Dillwyn, Va., USA. Note that the discussion of “purity” of FeS₂ acknowledges that pyrite is a specific and preferred mineral form of FeS₂. However, pyrite often times has small levels of impurities (e.g., silicon oxides) and, because only the FeS₂ is electrochemically active in pyrite, references to percent purity of FeS₂ may be made with respect to the total amount of pyrite including impurities provided in the cell. Additionally, pyrite may naturally vary, in terms of the stoichiometric amount of sulfur and iron found and/or in terms of the natural or deliberate introduction of certain dopants (e.g., metals in comparatively small amounts, preferably integrated within the structure of the pyrite). Thus, it should be understood that both the terms pyrite and FeS₂ generically also encompass these natural or synthetic variations, and for the purposes of any analytical characterization or electrochemical calculation/reaction, it is appropriate to treat the entirety of the electrochemically active material as FeS₂.

The following are representative materials utilized in the preferred cathode mixture formulation. between 91 wt. % to 99 wt. % pyrite, 0.1-3.0 wt. % conductor, about 0.1-3.0 wt. % binder, and about 0-1.0 wt. % processing aids. It is more desirable to have a cathode mixture with about 95-98 wt. % pyrite, about 0.5-2.0 wt. % conductor, about 0.5-2.0 wt. % binder, and about 0.1-0.5 wt. % processing aids. It is even more desirable to have a cathode mixture with about 96-97 wt. % pyrite, about 1.0-2.0 wt. % conductor, about 1.0-1.5 wt. % binder, and about 0.3-0.5 wt. % processing aids. A preferred cathode formulation is disclosed in U.S. Patent Publication 20090104520, which is incorporated by reference. The conductor may comprise carbon black, graphite or similar materials, which are widely available from, for example, Superior Graphite in Chicago, Ill. or Timcal in Westlake, Ohio. The binder may comprise a polymeric binder comprising a styrene-ethylene/butylenes-styrene (SEBS) block copolymer, such as those available from Kraton Polymers Houston, Tex. Processing aids are described in U.S. Pat. No. 6,849,360, which is incorporated by reference.

It is also desirable to use cathode materials, and particularly pyrite, with small particle sizes to minimize the risk of puncturing the separator. For example, the pyrite can be sieved, at least through a 230 mesh (62 μm) screen or smaller. More preferably, the pyrite may be media milled to have an average particle size between 1-19 μm, and most preferably between 6-12 μm, as described in U.S. Patent Publication No. 20050233214, which is incorporated by reference herein.

The cathode mixture is coated onto a metallic foil current collector, typically an aluminum foil with a thickness between about 16 and 20 μm, to form the cathode. The cathode mixture contains a number of materials that must be carefully selected to balance the processability, conductivity and overall efficiency of the coating, as described above. These components are mixed into a slurry in the presence of a solvent, such as trichloroethylene, and then coated onto the current collector. The resulting coating is preferably dried and densified after coating, and it consists primarily of iron disulfide (and its dopants and impurities); a binder to hold the particulate materials together and adhere the mixture to the current collector; one or more conductive materials such as metal, graphite and carbon black powders to provide improved electrical conductivity to the mixture; and various processing or rheological aids, such as fumed silica and/or an overbased calcium sulfonate complex. Additionally, it has been determined that lithium-iron disulfide batteries intended for high rate applications inure benefits by providing an excess of theoretical interfacial input capacity in the cathode as compared to the theoretical interfacial input capacity of the anode associated therewith, as described in U.S. Pat. No. 7,157,185 which is incorporated by reference herein. Thus, in one embodiment, cells of the invention have a preferred interfacial anode to cathode input ratio of less than 1.00, less than 0.95 or less than 0.90. When calculating these ratios, only the interfacially aligned portions of the electrodes should be used and the outermost circumference of the jellyroll should be discounted (i.e., depending upon the electrode oriented on the outer-most wind, either one-half of the anode thickness or the coating of the cathode or facing the inner diameter of the container).

The cathode mixture is applied to the foil collector using any number of suitable processes, such as three roll reverse, comma coating or slot die coating. After or concurrent with drying to remove any unwanted solvents, the resulting cathode strip is densified via calendering or the like to further compact the entire positive electrode. In light of the fact that this strip will then be spirally wound with separator and a similarly (but not necessarily identically) sized anode strip to form a jellyroll electrode assembly, this densification helps maximize loading of electrochemical material in the jellyroll electrode assembly.

Aluminum foil is a preferred cathode current collector, although titanium, copper, steel, other metallic foils and alloys thereof are also possible. The current collector may extend beyond the portion of the cathode containing the cathode mixture in order to provide a convenient area for making contact with the electrical lead connected to the positive terminal, as described below. Regardless of the means of establishing contact between the collector and the terminal, it may be desirable to eliminate or minimize such “mass free zones” (i.e., the portion of the current collector without cathode coating) to make as much of the internal volume of the cell available for active materials and electrolyte. Additional or alternative “mass free zones” can be provided on one or both sides of the cathode along the leading (i.e., the portion forming the core of the jellyroll) or trailing (i.e., the portion oriented on the outer-most wind/circumference of the jellyroll) edges. Examples of typical coating configurations for the cathode can be found in U.S. Patent Publication No. 20080026293.

The cathode should not be over-densified, as internal cathode voids helps: a) compensate for some of the cathode expansion during discharge, and b) wetting of the iron disulfide by the organic electrolyte. More practically, there are also operational limits as to the amount of force that can be applied to compact the coatings to high densities, and the stress on the current collector created by such forces can result in unwanted stretching and/or actual de-lamination of the coating. Therefore, it is preferable that the solids packing percentage in the final densified cathode must be sufficient to allow for the electrochemical reaction to proceed. Preferably, the final solids packing must be between 50% and 85%, and more preferably between 58% and 70%.

The cathode is electrically connected to the positive terminal of the cell. This may be accomplished with an electrical lead, often in the form of a thin metal strip or a spring, as shown in FIG. 1, although welded connections are also possible. If used, this lead can be made from nickel plated stainless steel or other appropriate materials. In the event an optional current limiting device, such as a standard PTC, is utilized as a safety mechanism to prevent runaway discharge/heating of the cell, a suitable PTC is sold by Tyco Electronics in Menlo Park, Calif., USA. Additional or alternative current limiting devices can be found in U.S. Publication Nos. 20070275298 and 20080254343, which are incorporated by reference.

The anode, cathode and separator strips are combined together in an electrode assembly. The electrode assembly must be a spirally wound design, such as that shown in FIG. 1, and it can be made by winding alternating strips of cathode, separator, anode and separator around a mandrel. At least one layer of separator and/or at least one layer of electrically insulating film (e.g., polypropylene) may be wrapped around the outside of the electrode assembly to hold the assembly together, to adjust the width or diameter of the assembly to a desired dimension and/or to insulate the assembly in a manner consistent with the polarity of the container and the electrical connects made with each terminal. The outermost end of the separator or other outer film layer may be held down with a piece of adhesive tape or by heat sealing. The anode can be the outermost electrode, as shown in FIG. 1, or the cathode can be the outermost electrode. Either electrode can be in electrical contact with the cell container, but internal short circuits between the outmost electrode and the side wall of the container can be avoided, inter alia, by matching the polarity of the outermost wind of the electrode assembly to that of the can.

In one embodiment of the invention, the jellyroll electrode assembly is constructed so that, as the cathode expands, the void space located within the central aperture of the assembly along the axial region of the electrode assembly where the electrodes are interfacially aligned (also referred to hereafter as the core) shrinks in a controlled and uniform fashion. In another embodiment, the core of the electrode assembly is constructed so that it will not collapse and, instead, redirect the expanding cathode outward in a controlled and uniform manner. In either case, the electrode assembly may be concentrically disposed around a cylindrical rod, inserted or integrally manufactured into the electrode assembly, which then serves as the core. Additionally or alternatively, the electrode assembly may be compressed or wound in a manner that controls the shape of the core in the electrode assembly. In each instance, the core of the electrode assembly is deliberately conformed so that the electrode assembly uniformly maintains its integrity as the battery is subsequently discharged. That is, the electrode assembly is manipulated so that the individual electrodes and the separator in the assembly are not punctured, severed or otherwise compromised in a manner that would cause shorting of the cell and/or a loss of expected capacity.

In a preferred embodiment, a cylindrical rod is inserted into the central aperture of the electrode assembly. Notably, the inner circumferential diameter of the container shape is typically circular, while the outer circumferential diameter of the cylindrical rod (also interchangeably referred to herein as the cross sectional shape) may have the same shape as the container or a different shape as described in greater detail below. Exemplary cross sectional shapes for the rod include circular, oval, rectangular, triangular or C-shaped, while exemplary cross sectional shapes for the container are circular or rectangular. Preferred cross sectional shapes of a non-circular rod will include at least one substantially flattened portion, in comparison to the remainder of the circumference of the core shape, which results in a recessed region along the core having a larger radius between the inner diameter of the central aperture and the outer diameter of the electrode assembly (i.e., the inner diameter of the container), while the preferred cross sectional shape of the container is circular. The height of the rod preferably matches the height of the inner portion of the container which houses the electrode assembly; however, in certain embodiments, it may be possible to utilize a rod which only conforms a portion of the overall electrode assembly's height.

The rod may be made of a solid or hollow material of sufficient strength to conform the electrode assembly as described above. The material must be compatible and non-reactive with the electrolyte, active materials and other components inherent to the battery. As such, any of the aforementioned metals or polymers used in the other non-active internal components may be candidates for use as a core material. Preferred materials include aluminum, stainless steel, nickel plated cold rolled steel, polypropylene, polyethylene and ethylene chlorotrifluoroethylene copolymers. If hollow, the rod may or may not be collapsible, and/or otherwise integrated with the venting or other mechanisms and components present in the cell. The rod may also include other integral features, such as flanges or slits, to receive portions of the electrode assembly components and to streamline and simplify the winding process. The rod may be provided as an integral winding mandrel which remains in the electrode assembly (thereby serving as the cylindrical rod, also referred to as “solid core winding”).

The core may also be integrally formed as part of the cathode current collector. In a preferred embodiment and as described in U.S. Patent Publication No. 2008/0026293, uncoated portions of the current collector are oriented in or proximate to the winding mandrel for the electrode assembly. Because this portion of uncoated foil is preferably oriented within the winding mandrel, this winding procedure will result in the uncoated regions forming a non-collapsing core for the electrode assembly. According to this embodiment, at least one wind of coated or uncoated cathode may be provided. This type of core may possess the same shapes and features as described for the rod above.

Other methods for conforming the electrode assembly to uniformly maintain the integrity of the electrode assembly and/or to uniformly collapse the void space defined by the central aperture of the electrode assembly are possible, with or without the use of a cylindrical rod or integral current collector core. For example, as part of the manufacturing process of the electrode assembly, it is possible to wind the anode, cathode and separator and then compress the resulting assembly to impart one of the aforementioned shapes to the core. Additionally or alternatively, the winding process itself may be varied to achieve the same purpose. By way of example rather than limitation, these variations may include the use of a shaped mandrel, varying the speed or tension of one or more of the winding components and the like. It is expected that the relative rigidity of the cathode current collector may help retain conformity of the entire electrode assembly. Here again, the shapes described for the rod above are also applicable to this type of core.

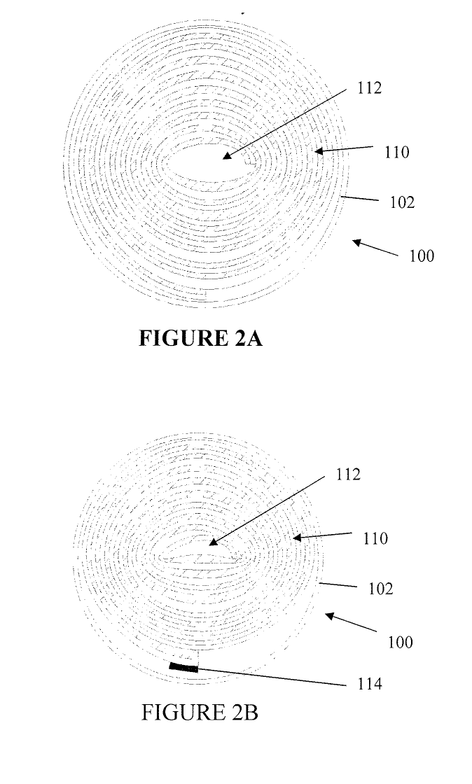

FIGS. 2A through 2C illustrate the comparative cross sectional shapes of a conformed electrode assembly, either through the use of a cylindrical rod (not shown) or by way of the other methods described herein. In each of these drawings, electrochemical cell 100 includes a container 102 with an electrode assembly 110 having a central aperture 112 disposed therein. FIG. 2A illustrates an oval shape that may be imparted to the electrode assembly, although it will be understood a rod shaped substantially in the same manner (i.e., having the same cross sectional shape) may be inserted into aperture 112. FIG. 2B illustrates a flattened rectangle or C-shape, while FIG. 2C is a triangular shape. Other optimized shapes may be possible without departing from the principles of the invention. Although not shown in FIG. 2A, an exemplary positioning for lead 114 is shown in FIGS. 2B and 2C. Also, throughout FIGS. 2A through 2C, the electrodes within the electrode assembly are intended to have a uniform thickness, although some of the graphical renderings may inadvertently give the appearance that some portions or gaps may be larger than others.

With respect to the lead, the location of any electrode lead(s) (anode or cathode) can be circumferentially aligned along the shape of the core to further optimize the benefits of the invention. For example, a lead can be attached at “flattened” portion of shaped core to reduce stress caused by lead as the battery is discharged and the cathode expands. Insofar as higher stresses are expected to be generated during discharge at the points of the outer diameter of the core that are closest to the inner diameter of the container (i.e., that possess the shortest distance between the two), the preferred location for any lead would be on or near the outer-most winds of the electrode assembly at a position that corresponds to the portion which has the greatest distance between the lead location and the core. In this embodiment, the core may include a cylindrical rod as previously described.

Other strategies are available to further accentuate the benefits of the invention. For example, particularly in the case of a non-collapsing core, a gap or continuous void can be engineered between the inner diameter of the container and the outer diameter of the electrode assembly. In this embodiment, all the leads are preferably welded to the container and/or top cover to minimize the risk of any disconnections. Another approach is to coat more cathode mixture, and thereby more active material, on the side of the current collector which faces outward (i.e., away from the core). This increase in solids packing/loading is expected to result in greater expansion forces being generated by that side of the current collector, which in turn will push the entire electrode assembly in an outward direction. The additional cathode material may be disposed by increasing the loading or solids packing of the cathode mixture on that particular side of the current collector.

Methods of manufacturing electrochemical cells, and more particularly lithium-iron disulfide batteries, are also contemplated. These methods simply adopt and apply the aforementioned principles to a production environment.

Without wishing to be bound by any particular theory, one of the primary functions of the core in all of these aforementioned embodiments is to uniformly redirect the expansion of the cathode as the battery is discharged. Previously, it was believed that a battery design must include sufficient void space, the majority of which was embodied in the central aperture of the electrode assembly, so as to allow for such expansion. As a radial expansion of the cathode takes place during discharge, inward forces are applied to the central aperture of the electrode assembly. These inward forces cause the circular aperture to buckle, resulting in high pressure points, as well as movement of the individual electrodes. The combined effect of the inward force and electrode movement then creates high localized pressure points which can result in a short between the electrodes. Other factors, such as minor variations in the cathode materials or coating, may further contribute to creation of these pressure points by causing a differential expansion rate which steadily worsens as the battery is discharged. Ultimately, these pressure points may puncture the separator and/or cause disconnects in one or both of the electrodes. The effects of these pressure points may be further exacerbated by the presence of electrical leads within the winds of the assembly.

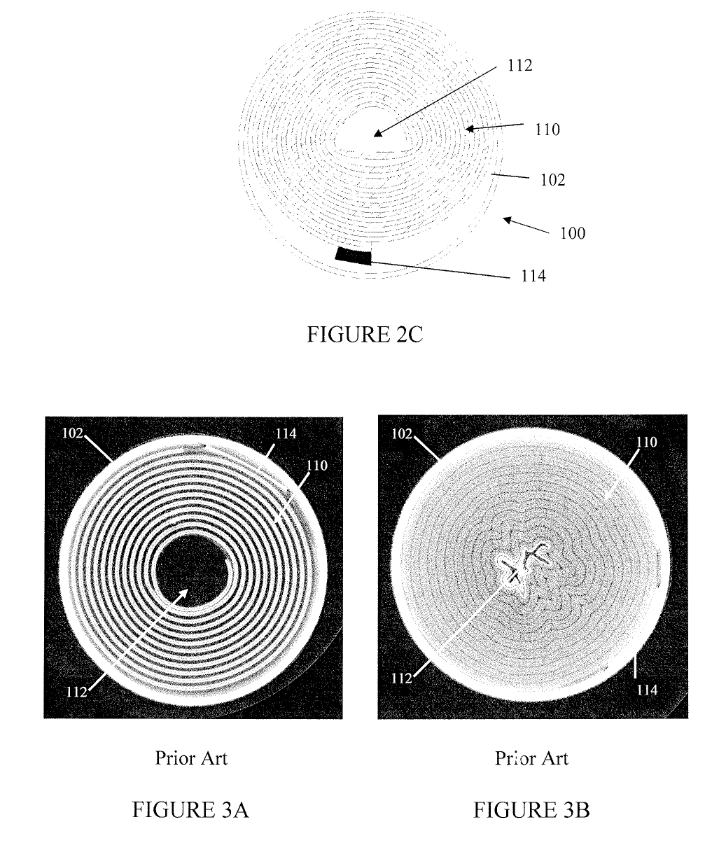

FIGS. 3A and 3B illustrates “before and after” negative image, cross sectional photographs of an lithium-iron disulfide electrode assembly of the prior art. In FIG. 3A, the central aperture 112 possesses the same circular shape as container 102. FIG. 3B illustrates the same battery after it has been discharged at 250 mA continuous drain to a 0.8 volt cutoff In FIG. 3B, the central aperture 112 has clearly collapsed in a non-uniform manner, with the jagged edges of its inner diameter/circumference indicating the likely presence and effects of the aforementioned pressure points. Also, note that both FIGS. 3A and 3B are actual images of a cell; therefore the relatively large volume of the void provided by the central aperture (in comparison to void present in the separator or cathode coating) should be readily apparent.

In view of the foregoing, by reducing or eliminating the void space in the central aperture that was previously deemed as essential and instead uniformly controlling how and where the cathode expands (i.e., conforming the core of the electrode assembly), it is now possible to preserve the integrity of the electrode assembly throughout the discharge life of the battery. As a result, batteries using these inventive concepts deliver more consistent and reliable service, and their overall average capacity, especially at low drain rates (e.g., ≦20 mA continuous) and at high temperatures (e.g., ≧60° C.), is improved.

The amount of FeS₂ in the cathode coating can either be determined by analyzing the mixture prior to fabrication of the battery or by determining the iron content post-formulation and correlating the detected level of iron to the weight percentage of pyrite in the cathode. The method of testing for iron content post-fabrication can be conducted by dissolving a known amount (in terms of mass and volume/area) of cathode in acid, then testing for the total amount of iron in that dissolved sample using common quantitative analytical techniques, such as inductively coupled plasma atomic emission spectroscopy or atomic absorption spectroscopy. Testing of known coated cathode formulations according to this method have verified that the total amount of iron is representative of FeS₂ in the cell (particularly to the extent that is desirable to maximize the purity of FeS₂ in the cathode coating). It may also be possible to determine cathode density using a pycnometer, although certain binders may experience volumetric changes when exposed to the internal environment of a lithium-iron disulfide cell such that the density established by such methods may need to be adjusted further in order to arrive at the cathode dry mix density.

Notably, testing for the quantity of aluminum in the sample will allow for calculation of the thickness of the current collector (when the collector is aluminum) in a similar manner (e.g., ICP-AES or AA spectroscopy). Other similar analytical techniques may be employed to test for binders, processing aids and the like, depending upon the atomic and/or molecular composition of those components. Analysis of the anode, sealing member(s) and/or separator is possible using similar analytical and quantitative/qualitative techniques.

To the extent that the weight per unit area of the cathode (or any other cell component, trait or feature that may be influenced by the presence of electrolyte) is to be determined from an already fabricated battery, the cathode/component should be rinsed with an appropriate solvent to remove any electrolyte remnants and thoroughly dried to insure solute or solvent from the electrolyte does not contribute to the measurement. In the event only one aspect of a multi-component part is desired, the contributions from constituent parts (e.g., the current collector from the cathode) may also be subtracted from the measurement through the appropriate empirical analysis of the collector described above. Additional, alternative or complimentary techniques and analyses can be readily developed by those having skill in this art to further assist in the determination of pertinent features.

The entirety of the above description is particularly relevant to FR6 and FR03 cells. However, the invention might also be adapted to other cylindrical cell sizes where the sidewall height exceeds the diameter of the container, cells with other cathode coating schemes and/or seal and/or pressure relief vent designs.

Features of the invention and its advantages will be further appreciated by those practicing the invention. Furthermore, certain embodiments of the components and the performance of the cell assembled as described will be realized. It will be understood by those who practice the invention and those skilled in the art that various modifications and improvements may be made to the invention without departing from the teachings of the disclosed concepts. The scope of protection afforded is to be determined by the claims and by the breadth of interpretation allowed by law.

What is claimed:

1. A 1.5 volt, primary lithium-iron disulfide battery comprising:
a round, cylindrical container with a top cover fitted over an open end of the container;
a spirally wound electrode assembly including an anode consisting essentially of metallic foil of lithium or a lithium alloy, a polymeric separator and a cathode comprising a cathode mixture including iron disulfide at least partially coated onto both sides of a metallic current collector; and
a core disposed concentrically within the electrode assembly to promote uniform expansion of the cathode mixture as the battery is discharged.

2. The battery according to claim 1, wherein the core comprises an inert, cylindrical rod.

3. The battery according to claim 2, wherein the rod is constructed from an insulating polymer.

4. The battery according to claim 3, wherein the polymer is selected from the group consisting of: polypropylene, polyethylene and ethylene chlorotrifluoroethylene copolymer.

5. The battery according to claim 1, wherein the core comprises a portion of the cathode.

6. The battery according to claim 5, wherein the portion of the cathode at the core is not coated with cathode mixture.

7. The battery according to claim 5, wherein the portion of cathode constitutes more than one wind of the spirally wound electrode assembly.

8. The battery according to claim 1, wherein the core has a cross-sectional shape that is not the same as the cross-sectional shape of the container.

9. The battery according to claim 8, further comprising at least one lead affixed to the electrode assembly at a point selected to reduce stress on the electrode assembly caused by the lead as the battery is discharged.

10. The battery according to claim 1, wherein the cross-sectional shape of the core is selected from the group consisting of: circular, oval, rectangular, triangular or C-shaped.

11. The battery according to claim 1, wherein the core is constructed to collapse in a uniform manner as the battery is discharged.

12. The battery according to claim 1, wherein the metallic current collector has an outer facing side and an inner facing side and wherein a greater amount of iron disulfide is coated onto the outer facing side as compared to iron disulfide coated onto the inner facing side.

13. The battery according to claim 1, further comprising a welded lead electrically connecting the electrode assembly to either the container or the top cover and wherein the electrode assembly has an outer diameter and the container has an inner diameter so that, prior to discharge of the battery, a continuous void exists between the inner diameter and the outer diameter.

14. The battery according to claim 1, wherein the core comprises a winding mandrel.

15. An electrochemical cell comprising:
a cylindrical container having a height that is greater than a diameter;
a spirally wound electrode assembly including an anode, a separator and a cathode; and
a cylindrical core concentrically disposed within the electrode assembly having a cross sectional shape that differs from a cross sectional shape of the cylindrical container across the entire height of the container.

16. The electrochemical cell according to claim 15, wherein the cross sectional shape of the cylindrical container is circular.

17. The electrochemical cell according to claim 16, wherein the cross sectional shape of the cylindrical core is selected from the group consisting of: oval, rectangular, triangular or C-shaped.

18. The electrochemical cell according to claim 15, wherein the cylindrical core is hollow.

19. The electrochemical cell according to claim 15, wherein a lead is affixed within the electrode assembly proximate to a flattened circumferential portion of the cross sectional shape of the core.

20. The electrochemical cell according to claim 15, wherein the core is constructed to collapse in a uniform manner as the battery is discharged.

21. The electrochemical cell according to claim 15, wherein the core comprises a winding mandrel.

22. A method of manufacturing a primary lithium-iron disulfide battery comprising:
creating a spiral wound electrode assembly including a lithium or lithium alloy anode and an iron disulfide cathode at least partially coated onto both sides of a thin metallic strip so that the electrode assembly has an outer circumferential shape and a central aperture with an inner circumferential shape;
conforming the electrode assembly so as to uniformly maintain integrity of the electrode assembly when the battery is subsequently discharged; and
disposing the electrode assembly within a cylindrical container having a height that is greater than a diameter.

23. The method according to claim 22, wherein the conforming the electrode assembly is accomplished by disposing a cylindrical rod concentrically within the central aperture of the electrode assembly.

24. The method according to claim 23, wherein the cylindrical rod is designed to collapse in a uniform manner as the battery is subsequently discharged.

25. The method according to claim 23, wherein the cylindrical rod has a outer circumferential shape that: i) matches the inner shape of the central aperture, and ii) is different from a shape of the cylindrical container.

26. The method according to 25, wherein the outer shape of the cylindrical rod is selected from the group consisting of: oval, rectangular, triangular or C-shaped.

27. The method according to claim 22, wherein the conforming the electrode assembly is accomplished by physically compressing the electrode assembly to alter the inner shape of the central aperture.

28. The method according to 27, wherein the inner shape of the central aperture is selected from the group consisting of: oval, rectangular, triangular or C-shaped.

29. The method according to claim 23, wherein the conforming the electrode assembly is accomplished by coating more iron disulfide on one side as compared to an opposing side of the thin metallic strip.

30. The method according to claim 23, wherein the electrode assembly has an outer diameter and the container has an inner diameter and the electrode assembly is disposed within the container so that, prior to discharge of the battery, a continuous void exists between the inner diameter and the outer diameter and further comprising welding a lead electrically connecting the electrode assembly to either the container or a top cover fitted over an open end of the container.

31. The method according to claim 23, wherein the cylindrical rod is a winding mandrel used to create the spiral wound electrode assembly.

32. A method of manufacturing a battery comprising:
creating a spiral wound electrode assembly so that the electrode assembly has an outer circumferential shape and a central aperture with an inner circumferential shape;
conforming the electrode assembly so as to impart a shape to the central aperture that is different than the outer circumferential shape of the assembly; and
disposing the electrode assembly within a cylindrical container having a height that is greater than a diameter.

33. The method according to claim 32, wherein the conforming the electrode assembly is accomplished by disposing a cylindrical rod concentrically within the central aperture of the electrode assembly and wherein the cylindrical rod having a outer circumferential shape that: i) matches the inner shape of the central aperture, and ii) is different from a shape of the cylindrical container.

34. The method according to 33, wherein the outer circumferential shape of the cylindrical rod is selected from the group consisting of: circular, oval, rectangular, triangular or C-shaped.

35. The method according to claim 33, wherein the cylindrical rod is a winding mandrel used to create the spiral wound electrode assembly.

36. The method according to claim 32, wherein the conforming the electrode assembly is accomplished by physically compressing the electrode assembly.
